(19) United States
(12) Patent Application Publication
(10) Pub. No.: US 2022/0095669 A1
(43) Pub. Date: Mar. 31, 2022

(54) TEXTURE MODIFIED FOOD PRODUCT

(71) Applicant: I Cook Catering Services Pty Ltd, Dandenong South, Victoria (AU)

(72) Inventors: Ian William Cook, Cleveland, Queensland (AU); Michael Andrew Cook, Blackburn, Victoria (AU)

(21) Appl. No.: 17/049,181

(22) PCT Filed: Apr. 18, 2019
(86) PCT No.: PCT/AU2019/050348

§ 371 Date: Oct. 20, 2020

(30) Foreign Application Priority Data
Apr. 20, 2018 (AU) 2018202788

(51) Int. Cl. A23P 30/10; A23L 19/00; A23L 19/12; A23L 5/10; A23L 29/269; A23L 29/212; A23B 7/148; A23B 7/04; B65B 47/10; B65B 11/52; B65B 31/04; B65B 25/00

(52) U.S. Cl. CPC A23P 30/10; A23L 19/09; A23L 19/13; A23L 5/13; A23L 29/27; A23L 29/212; A23V 2002/00; A23B 7/04; B65B 47/10; B65B 11/52; B65B 31/046; B65B 25/001; A23B 7/148

(57) ABSTRACT

The invention is directed broadly to a method of preparing a texture modified food product, comprising the steps: (a) providing a partially cooked fruit or vegetable; (b) comminuting the partially cooked fruit or vegetable to form a paste; and (c) moulding the paste to form the texture modified food product which is shaped and/or textured into a generic shape of the fruit or vegetable selected to form the paste.

### TECHNICAL FIELD

The invention relates to the field of texture modified foods, also referred to as puree foods. Specifically, the invention relates to a method of preparing a selected fruit or vegetable and also to a texture modified fruit or vegetable product formed to resemble the selected fruit or vegetable. The invention also relates to a method of forming and packaging the texture modified fruit or vegetable product.

### BACKGROUND

For many people, whether through age, dental condition, illness or accident, the act of swallowing becomes laboured, painful or even impossible. The loss of the ability to swallow is given the medical name dysphagia and refers to the specific medical condition where the passage of solids or liquids from the mouth to the stomach becomes difficult.

The effects of dysphagia can be physical, where the disphagic individual is susceptible to pulmonary aspiration and possible aspiration pneumonia brought about by food going into the lungs and not into the oesophagus. In some cases, this condition can be managed with texture modified foods “tmf”. However, there is a delicate balance to be found between puree foods which are not so runny as to leak into the larynx and trachea but conversely not so solid to require chewing or manipulation and not sticky so as to become adhered to the palate. This balance is further complicated when foods are susceptible to heat, as the heat of the mouth can rapidly decrease the viscosity of certain foods.

Often overlooked is the psychological effect of dysphagia. A disphagic individual may be nutritionally stable on a tmf diet but no longer feels comfortable to eat in front of others. Furthermore, a tmf option is seldom available at restaurants, such that a disphagic individual cannot elect to eat at a restaurant with friends and family and thus become isolated from many of the social aspects of dining.

Typically, tmf is prepared as a puree by boiling or steaming a vegetable until it is very soft and can be blended with sufficient liquid (stock or cooking water), until smooth. The blended puree is then thickened with any starch, commonly mashed potato or tapioca starch. The finished puree is then plated in measured dome-shaped scoops. Made in this traditional manner, the product lacks aesthetic appeal due to dull or faded colour as a result of the heating processes, and is also of poor nutrient density, which happens because of the dilution effect of adding the stock or cooking water required to achieve the puree end product.

The present invention was conceived with these shortcomings in mind.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

### SUMMARY OF THE INVENTION

The invention provides a method of preparing a texture modified food product, comprising the steps: (a) providing a partially cooked fruit or vegetable; (b) comminuting the partially cooked fruit or vegetable to form a paste; and (c) moulding the paste to form the texture modified food product which is shaped and textured into a generic shape of the fruit or vegetable selected to form the paste.

The step of providing a partially cooked fruit or vegetable may comprise commencing the cooking of the raw fruit or vegetable, then arresting the cooking of the fruit or vegetable. The partially cooked fruit or vegetable may be cooked until just tender.

The step of comminuting the partially cooked fruit or vegetable may comprise chopping (as herein defined) the partially cooked fruit or vegetable.

The method may further comprise the step of assessing the consistency of the paste. Where necessary, the consistency of the paste may be adjusted.

The step of moulding the paste to form the texture modified food product may comprise setting the paste in a mould.

The invention also provides a method of preparing a texture modified food product, comprising the steps: (a) commencing cooking of a raw fruit or vegetable; (b) arresting the cooking of the fruit or vegetable to provide a partially cooked fruit or vegetable; (c) chopping the partially cooked fruit or vegetable finely to form a paste; and (d) setting the paste in a mould to form the texture modified food product shaped and textured to a generic shape of the fruit or vegetable selected to form the paste.

The method facilitates the production of realistic food portion sizes that further reflect a realistic looking fruit or vegetable form. The method provides texture modified food products that closely resemble the original fruit or vegetable in form, texture, taste and nutritional content. The texture modified food products provided promote the appetite of the consumer and also reinstate a modicum of normalcy to meal times and dining occasions.

The process does not rely on excessive heating, and diluting of the natural products with broths and stocks that can result in the dilution of nutrients in the end product and the damage to the colour, and flavour profile of the finished product.

The step of cooking the raw fruit or vegetable may involve plunging the fruit or vegetable into boiling water for a predetermined time period.

The step of arresting the cooking of the fruit or vegetable may involve plunging the fruit or vegetable into cold water and/or iced water.

The step of arresting the cooking of the fruit or vegetable may include blast chilling the partially cooked fruit or vegetable.

This provides benefits to many fruits and vegetables and particularly to green fruit and vegetables: as the chlorophyll therein is released during cooking. Cooking beyond the tender stage results ultimately in a grey, dark green subdued colour that is neither appetising nor appealing. Arresting the cooking process is a very rapid cooling of the fruit or vegetable that not only stops the cooking process but can also increase the vibrancy of the fruit or vegetable providing a fresh, appetising colour to the finished texture modified food product.

The step of chopping the partially cooked fruit or vegetable may be performed with a shear-blade cutter or a bowl cutter. The step of chopping the partially cooked fruit or vegetable may additionally be comprised of continuing the chopping of the partially cooked fruit or vegetable until the paste takes on a mousse-like consistency. The step of adjusting the mixture may involve repeating the chopping step.

The term “chopped” as used herein is intended to describe broadly the process of physically breaking down the partially cooked fruit or vegetable into small enough pieces to form a paste, as such chopping includes, cutting, slicing, and dicing etc. The particles can range anywhere in size from 5-40 microns, and the exact particle size of the chopped fruit or vegetable will vary for different raw products.

The step of assessing the consistency of the paste additionally may involve adjusting the mixture to increase the viscosity of the paste to meet a predetermined standard.

The method may further comprise the step of introducing an additive into the mixture prior to setting the paste in the mould. The additive may be selected from at least one of: Xanthan gum; modified potato starch; agglomerated modified potato starch (AMPS); natural vegetable fibre; bamboo fibre; flavourless starch; salt and pepper.

The ability to hold shape and texture of the final texture modified food product is advantageous through the transportation, unpackaging, plating and heating processes. If these processes resulted in excessive damage to the shape and texture of the product when plated before the consumer, the resemblance to non-textured food could be lost along with the appeal and opportunity to positively affect the consumer's appetite.

The method may comprise the step of introducing the paste into the mould while warm, prior to setting the paste in the mould. The method may comprise the step of introducing the paste into the mould while cold, prior to setting the paste in the mould.

The method may further comprise the step of integrating the mould with a thermoforming machine.

The method may maintain the mould at a temperature below 1 degree Celsius to set the texture modified food product.

The mould may provide a recess shaped and/or textured to the generic species of the raw fruit or vegetable selected to form the paste. The mould may provide a plurality of recesses shaped and/or textured to the generic species of the raw fruit or vegetable selected to form the paste. Each of the plurality of shaped recesses may have an equal volume.

The method may further comprise the step of lining the mould with a first layer of packaging material prior to introducing the paste therein.

The mould may be configured as a die. The die may provide at least one venting hole therein, to draw air from the recesses shape into the die. The die may be connectable with a vacuum forming machine or with a thermo-forming machine.

The method may include the step of vacuum assisting the drawing of the first layer of packaging material into the mould prior to receiving the paste.

The venting holes in the die require redesign and modification to support the drawing of the lining material into complex curves and recesses of a realistic mould shape. This requires detailed analysis of the form to be created and significant work to achieve an even draw across the surface of the mould.

The method may further comprise the step of operatively engaging the mould with a thermo-forming machine. The method may further comprise the step of disposing a second layer of packaging material over the mould after the paste has been received therein, and fusing the second layer with the first layer of packaging material thereby forming a sealed pouch around the moulded texture modified food product.

The texture modified food products can be formed in individual portions in full three-dimensional forms or in flat-bottoms shapes, that are easily retained on a plate and cannot roll about.

The lining material protects the moulded texture modified food product reducing contamination risk. The lining material also increases production rates achievable from a single set of moulds.

Without the lining each filling, freezing and releasing of the mould would require a full clean, sterilisation and drying step before another batch of the product can be formed. The sterilisation step would be further complicated with the plurality of air vents running from the mould into the die.

The die of the present invention is lined with a sterile film to form a new mould each time before receiving the paste which is formed and frozen, then released for the next batch to begin. The finished texture modified food product is instantly sealed into the packaging reducing additional handling steps thereby reducing contamination risk. The next time the product is contacted is when it is released from the package ready for imminent consumption.

The method may further comprise the step of air evacuating the sealed pouch prior to sealing. This can reduce the possibility of freezer burn on the finished texture modified food products. This step provides advantages in increasing the shelf-life of the finished product.

The method may further comprise the step of back-flushing the pouch with carbon dioxide and nitrogen to remove suspended oxygen from the moulded texture modified food product prior to sealing the pouch.

The method may further comprise the step of hot pasteurising the sealed pouch to increase usable shelf life of the packaged product. The method may further comprise the step of cold pasteurising the sealed pouch to increase usable shelf life of the packaged product.

The method may further comprise the step of freezing the sealed pouch for distribution.

In a second aspect, the invention provides a texture modified food product made by the method described herein.

In one aspect, the invention provides a texture modified food product, comprising; a paste formed from fruit or vegetable species, the paste retaining the colour, nutritional content and the taste or the fruit or vegetable species; and an additive selected from a group comprising: Xanthan gum; Guar gum; modified potato starch; agglomerated modified potato starch (AMPS); natural vegetable fibre; bamboo fibre; flavourless starch; salt and pepper, wherein the texture modified food product is shaped and textured to a generic shape of the fruit or vegetable species selected to form the paste.

The paste may be made from any one of the following: artichoke, apple, asparagus, avocado, banana, beans, broccoli, Brussel sprouts, cabbage, carrot, cauliflower, celery, corn, courgette, cucumber, eggplant, lemon, lettuce, lime, melon, olive, onion, orange, peach, pear, peas, plums, potatoes, pumpkin, raspberry, spinach, squash, strawberry, sweet potato, swede, tomato and turnip.

The above list of fruits and vegetable are merely examples and most fruits and vegetables can be processed in the above described manner. This provides the ability to present a restaurant quality meal in terms or presentation and flavour that promotes social inclusion.

The texture modified food product may be adjusted in portion size to suit a consumer's appetite.

The texture modified food product may be pre-planned and plated, prior to heating for consumption.

The texture modified food product may be plated frozen.

The texture modified food product may retain its shape through a thawing or heating process.

The texture modified food product may be reheated during a meal without loss of shape or colour.

A plurality of texture modified food products made from different fruit and vegetable products may be combined on a plate with meat products to present the consumer with a full meal. The individual texture modified food products on the plate may remain separate. The separation of individual texture modified products on a plate may be maintained through a thawing process. The separation of individual texture modified products on a plate may maintained through a heating process.

Individual texture modified food products are produced to a single taste profile. However, the individual components can then be plated to form a meal, a casserole or a stir fry, that brings these individual elements together but still provides for individual consumption. A consumer can eat the mashed potato, beef and vegetable products at their leisure and not be forced to confront or consume all meal components blended together in single serving or discoloured pulp.

The single serving of each product provides ultimate flexibility on portion size and nutritional content of a given meal to comply with recommended serving sizes from a dietician. As the texture modified food products do not require any cutting or additional processing there is little waste and a consistent presentation of the food products.

Various features, aspects, and advantages of the invention will become more apparent from the following description of embodiments of the invention, along with the accompanying drawings in which like numerals represent like components.

### BRIEF DESCRIPTION OF THE DRAWINGS

Embodiments of the invention are illustrated by way of example, and not by way of limitation, with reference to the accompanying drawings, of which:

FIG. 1 is a perspective view of a texture modified food product, the product is made from broccoli and configured to closely resemble broccoli according to an embodiment of the invention illustrated;

FIG. 1A is a perspective view of the food product of FIG. 1, illustrating a mould separation line, where two flat-bottom pieces formed into a 3-dimensional broccoli floret form;

FIG. 2 is a perspective view of a texture modified food product, illustrating a 3-dimensional food product, constructed from two flat-bottom moulded products formed into a 3-dimensional carrot form;

FIG. 3 is a perspective view of a meal combining a plurality of texture modified food products, each product formed from either a vegetable or a meat, to form a casserole meal;

FIG. 4 is a perspective view of a meal combining a plurality of texture modified food products where texture modified meat product is combined with a plurality of texture modified vegetable products which have been cut and sliced to form a stir-fry meal;

FIG. 5 is a perspective view of a meal combining a plurality of texture modified vegetable products with a texture modified meat product and a texture modified potato product, to form a roast meal;

FIG. 6A is a perspective view of a double-sided die for forming three-dimensional, flat bottomed vegetable products to resemble broccoli;

FIG. 6B is a top view of a die having three moulding recesses for forming three-dimensional, flat bottomed vegetable products to resemble broccoli, illustrating a plurality of air passages extending from the moulding recess into the body of the die;

FIG. 6C is a top view of a die having two moulding recesses for forming three-dimensional, flat bottomed vegetable products to resemble a serve of peas;

FIG. 7 is an end view of a packaged, three-dimensional vegetable product;

FIG. 8 is a perspective view of the packaged product of FIG. 7, which can be frozen and stored before being removed from the package and heated for consumption;

FIG. 9 is a perspective view of a die for forming a plurality of flat bottomed vegetable products simultaneously;

FIG. 10 is a schematic view of a texture modified paste being distributed into a moulding recess of FIG. 9, illustrating two layers of packaging material: a first inside the moulding recess and a second laid across the moulding recess, prior to thermoforming the finished texture modified food product;

FIG. 11A is an end view of a thermoformed package without a food product, providing a flat-bottomed fruit or vegetable product;

FIG. 11B is a top view of a thermoformed package having a top and a bottom portion configured to form a plurality of rounded, three-dimensional broccoli florets;

FIG. 11C is a front view of the package of FIG. 11B, illustrating the top and bottom portions aligned, without a textured food product therein;

FIG. 12A is a perspective view of a multi-pack of the texture modified fruit or vegetable product, illustrating perforation lines within the package;

FIG. 12B is a perspective view of a three-pack of the texture modified vegetable product in broccoli form;

FIG. 13A is a perspective view of a die for forming a texture modified food product, illustrating an air vent extending through a base of the die into a moulding recess on a top surface of the die, to assist in the forming process;

FIG. 13B is a sectional view through the moulding recess of the die in FIG. 13, illustrating a primary air passage in the base of the die and a plurality of supplementary air passages in fluid communication with the primary air passage and a surface of the moulding recess;

FIG. 14 is a perspective view of an alternative mould for forming a texture modified food product, illustrating a plurality of air vents through the mould to tailor the thermoforming process to more complicated mould forms;

FIG. 15 is a flow chart of a method for forming a texture modified food product from a single vegetable species

FIG. 16 is a perspective view of a meal combining a plurality of texture modified vegetable products with a texture modified meat product and a texture modified potato product, illustrating a coating applied to the potato product to resemble a fried potato chip.

Embodiments will now be described more fully hereinafter with reference to the accompanying drawings, in which various embodiments, although not the only possible embodiments, of the invention are shown. The invention may be embodied in many different forms and should not be construed as being limited to the embodiments described below.

### DETAILED DESCRIPTION OF EMBODIMENTS

Whist the texture modified food product described and illustrated herein is primarily in relation to broccoli, this is merely illustrative, and it is contemplated that the texture modified food product and method of preparation described herein is generally applicable to all manner of vegetables and fruits. Some steps of the process are adjustable to cater for individual fruits or vegetables which may require more rigorous processing due to their cellular structure, for example potatoes, or less rigorous processing, for example lettuce.

The term “food” as used herein is understood to refer generally to a plant or a part of a plant for human consumption. As such, the terms fruit and vegetable are broadly used to refer to pulses, beans, tuber, leaves, stalks, stems, roots, buds, seeds, flowers and all other parts of a plant that are consumed.

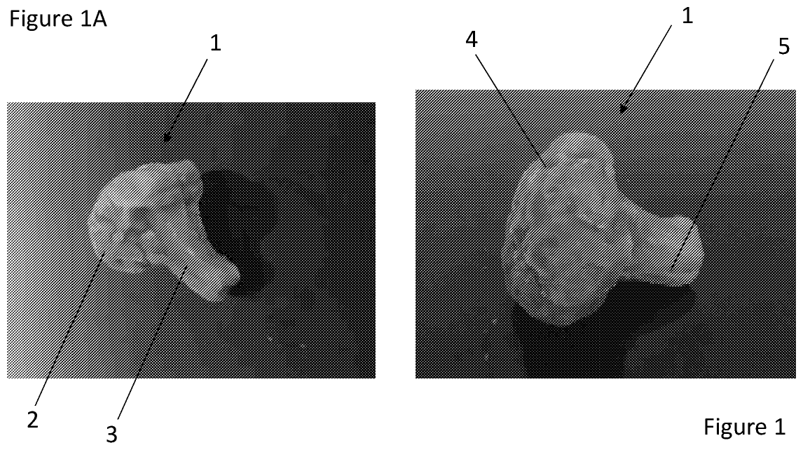

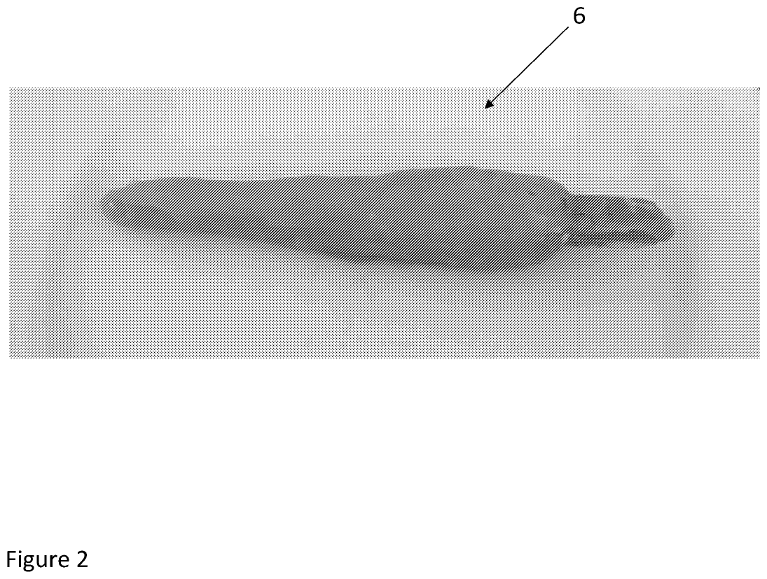

With reference to FIGS. 1, 1A and 2, there is provided a food product 1, comprising; a paste 32 formed from a single fruit or vegetable species, the paste 32 retaining the colour and the taste of the single fruit or vegetable species; and an additive selected from a group comprising: Xanthan gum; modified potato starch; agglomerated modified potato starch (AMPS); Guar gum; natural vegetable fibre; bamboo fibre; flavourless starch; salt and pepper, wherein the food product 1 is shaped and textured to a generic shape of the single fruit or vegetable species selected to form the paste 32.

It is contemplated that alternative agglomerated modified starches could be added to the food product 1. For example, agglomerated tapioca; arrow root; grain; quinoa; corn; chickpea; spelt; and chia, starch.

Due to the food preparation techniques described herein, and the flavour retained in the finished texture modified food, salt and pepper and similar seasonings are not required. However, some vegetable products can be flavour enhanced with salt and pepper, for example potato.

The paste 32 can be made from any one of the following: artichoke, apple, asparagus, avocado, banana, beans, broccoli, Brussel sprouts, cabbage, carrot, cauliflower, celery, corn, courgette, cucumber, eggplant, lettuce, olive, onion, orange, peach, pear, peas, plums, potatoes, pumpkin, spinach, squash, sweet potato, swede, tomato, turnip etc. It is further contemplated that combinations of the above vegetables can be used to form a mixed paste.

The internal texture of the fruit or vegetable product 1 is akin to a puree, in that a consumer will not need to chew the food product to break it down for swallowing. Conversely, the food product has a consistency that can withhold the shape and texture of the desired vegetable product 1 during and after being heated whether in a conventional oven or microwave.

The external texture of the food product 1 is formed from a moulding recess 22 of a die in which the product 1 is moulded. An internal surface 28 of the mould can be stippled or textured to resemble flowering buds 4 around a head 2 of broccoli of the product 1. Additionally, a second internal surface 31 of the mould can be textured to provide striations or a fibrous thread formation to resemble a stalk 3 of the texture modified broccoli product 1 in FIG. 1 or an outer finish to a whole carrot product 6, illustrated in FIG. 2.

A single half-vegetable moulding recess 22 can be used to form the texture food product 1, which gives the food product 1 a flat-bottom. This can assist in keeping the food product 1 on a plate and prevents the product 1 from rolling around. For some consumers, this can be advantageous. As the product 1 can be formed with a flat-bottom, an alternative presentation of the product 1 involves joining the flat-bottoms of two products to form a single rounded, 3D food product, as illustrated by the broccoli floret product of FIGS. 1 and 2. In FIG. 1A, a seam 5 can be seen where the two flat-bottomed products 1 have been joined together. In a still further embodiment, 3-dimensional dies/moulds can be manufactured to allow 3D, non-symmetrical food products to be formed.

The texture modified food product 1 in some embodiments, is configured to resemble a whole vegetable, for example a sprout or a carrot. In some embodiments, the food product 1 is configured to resemble a portion of the vegetable, for example a slice of pumpkin 14, an orange segment, or a floret of broccoli 1, as illustrated in FIGS. 1, 2 and 5.

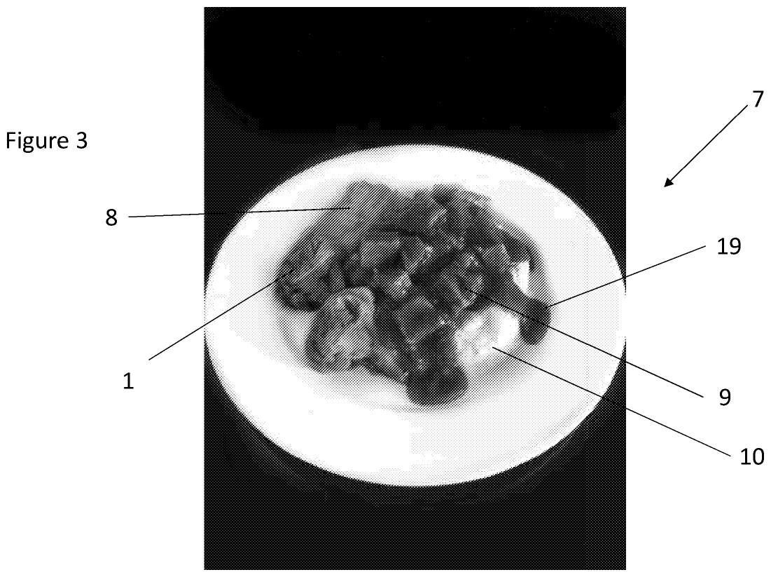

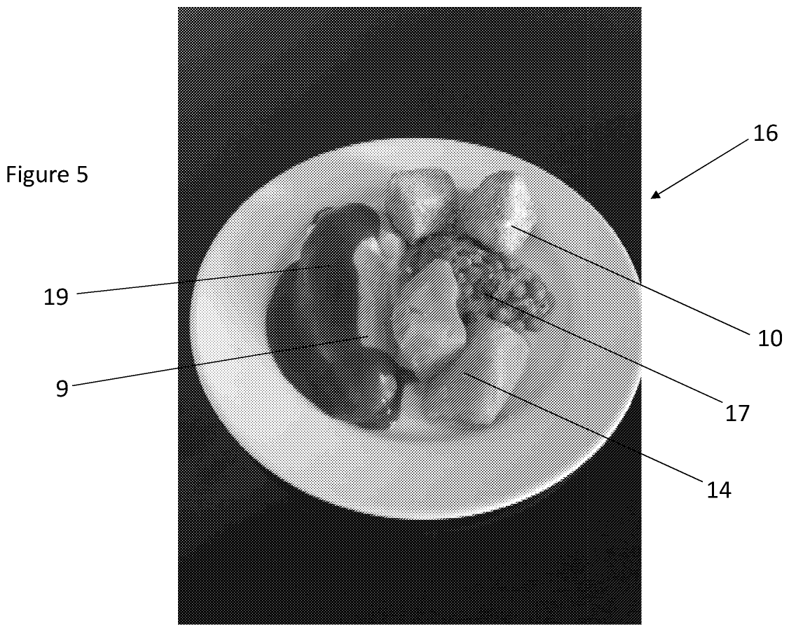

In other embodiments, the food product 1 is configured to resemble a serving of the vegetable, for example a serve of peas 17, carrots 8 or a serve of beans as illustrated in FIGS. 3 and 5. Additionally, the food product can be configured to resemble a cooked or prepared form of the selected vegetable in contrast to the raw vegetable itself, for example a slice of roasted pumpkin, or a boiled potato 10.

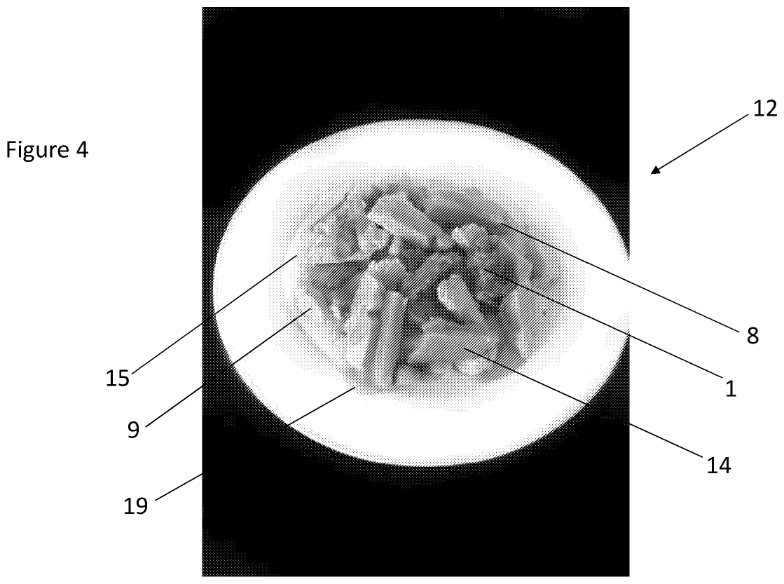

For a cooked embodiment of the vegetable product, the finished food product 1 can embody subtle deformities or surface flaws and defects, that give the appearance of a cooked vegetable, and not an overly idealised, “too perfect to be real” finish. In other embodiments, the texture modified food product 1 can be further divided or cut to give the appearance of a stir-fry dish, as illustrated in FIG. 4 served with a texture modified rice product 15.

In each of the meals (casserole) 7, (Stir fry) 12 and (roast) 16 of FIGS. 3, 4 and 5, a gravy 19 or sauce has been added to the texture modified meal product 9. The consistency of the gravy 19 is also required to conform to predetermined standards, as a runny gravy (low viscosity) will pose the same danger of entering the lungs as the texture modified food products that it is applied to for a dysphagic consumer.

The gravy 19 is not as viscous as the texture modified food product 1, and can be used to adjust the consistency of the texture modified food product 1, by the consumer, at the time of eating as it is not required by this invention to achieve the predetermined texture consistency standards. The gravy 19 can also compensate for any dehydration to the vegetable product 1 where it has been over heated and lost moisture. The addition of gravy 19 onto the texture modified vegetable product 1 also give the visual effect of cooked vegetables distinguishing from typical puree meals. An alternative sauce or sweet syrup can be used on fruit products to provide the benefits outline above from a gravy 19.

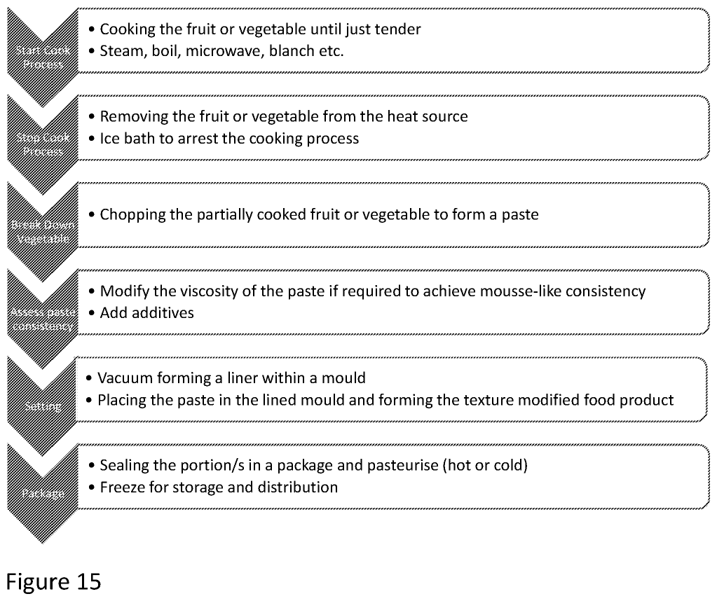

In one embodiment, illustrated in the flow process of FIG. 15, there is provided a method of preparing a food product 1, comprising the steps of:
a) commencing a cooking process of a selected fruit or vegetable;
b) arresting the cooking process of the fruit or vegetable;
c) chopping the partially cooked fruit or vegetable finely to form a paste 32;
d) assessing the consistency of the e paste 32; and
e) setting the paste 32 in a die 20 to shape and texture the food product to a generic shape of the fruit or vegetable selected to form the paste.

The cooking process is selected from one of the following cooking processes: blanching, boiling, steaming, baking, microwaving, braising, frying, grilling and roasting.

Blanching the vegetable in boiling water provides the opportunity to process a large amount of vegetables for volume production of the texture modified vegetable product 1. Blanching is a form of scalding the vegetable where the vegetable is exposed to boiling water for a brief time period before being removed and shocked, to arrest the cooking process. For some products 2-4 mins will be sufficient time to blanch the raw vegetable, where other vegetables may take 8-10 mins. There times will vary depending on the volume of water used and the starting temperatures of the raw vegetable. The fruit or vegetable is ideally cooked just until the fruit or vegetable becomes tender. Cooking until tender will reduce any graininess in the texture of the paste. The duration of time for cooking the fruit or vegetable will be highly dependent on the variety and quantity selected for cooking.

The blanching water can be salted for certain vegetables, for example broccoli. The period of exposure to the boiling water is typically not sufficient to overcook or break down the vegetable. Accordingly, the cooking process is stopped or arrested while the vegetable still retains its shape and colour.

Blanching inactivates enzymes in the vegetable which would otherwise detrimentally affect the flavour, colour, texture and nutritional value of the vegetable if stored for long periods. Moreover, blanching can remove intercellular gases from the vegetable to assist in retaining the natural colour thereof and soften the vegetable tissue.

The step of arresting the cooking process is the removal of the vegetable from heat. The arresting of the cooking process can further include the step of rapid cooling (shocking) of the partially cooked vegetable by placing the vegetable in a blast chiller or submerging the vegetable in cold or iced water. Iced water is effective for very quickly reducing the temperature of the vegetable after being removed from the heat source eg. boiling water.

For green vegetables blanching the vegetable until tender will retain the vibrant green colour (Chlorophyll, also known as E140) within the vegetable. Green vegetables are particularly susceptible to colour change when over-cooked, as Chlorophyll is incorporated into the raw vegetable as a gas and if not carefully monitored the cooking process will result in gas release and thereby colour-loss of the vegetable. This can result in a dark green or grey final colour which can be aesthetically unappealing and therefore unappetising.

Red vegetables, such as carrots and pumpkin require more cooking than green vegetables and should be cooked until soft. If red vegetables are only partially cooked for example until they start to tenderise but have not softened, the resulting vegetable paste can have a raw taste and grainy texture in lieu of a cooked taste, as desired for cooked red vegetables.

For many people, their appetite is not merely stimulated by taste but by the visual appearance and smell of food. As such, for people with anorexia (or loss of appetite) the appearance and smell of a food is increasingly important to stimulate their appetite.

Blanching the vegetable in boiling water also provides for the removal of some surface contaminants and bacteria from the surface of the vegetable.

Other methods of cooking the fruit or vegetables until tender can be used, for example steaming, microwaving, or boiling.

The partially cooked, cooled vegetable is then chopped to break down the flesh of the vegetable. As the vegetable needs to be finely chopped to attain the required consistency, a cutter or shear-blade is used. The blades need to be sharp so as not to bruise the vegetable but to cleanly cut the vegetable into minute pieces.

The method can employ an industrial sesame mill or a large bowl cutter, with multiple chopping blades rotating at 3000-6000 rpm.

When using mills, these mills can be refrigerated to keep the product chilled however, where the chopping process is carried out quickly, the refrigerated mill is no longer necessary and can thereby decrease operating costs. Mills can also be referred to as emulsifiers as the product after milling can become emulsified.

When using the bowl cutter, a plurality of blades is used, axially arranged on a shaft to process the tender cooked fruit or vegetables very quickly. When processing the fruit or vegetables, it is undesirable to create heat as this can increase the growth of bacteria, the increased processing rate of the bowl cutter is thus advantageous. The resulting fruit vegetable paste still holds the colour of the raw fruit or vegetable and is undiluted, thereby retaining a greater nutrient density than a typical boiled/blended fruit or vegetable puree.

As the fruit or vegetable is chopped, the fast-moving blades of the bowl cutter add air to the paste, and thereby aerate the paste. As the fruit or vegetable breaks down, there comes a point when the particle size of the chopped fruit or vegetable is approximately equal to the air bubbles introduced into the paste 32 and the paste can be seen to take on a mousse-like texture. Similar to whipping egg-whites, the paste 32 takes on a sheen and begins to form soft peaks. This an excellent indication that the particle size of the chopped fruit or vegetable has been achieved and that resulting paste 32 will not have a rough or grainy mouthfeel when consumed.

For many fruits and vegetables, the change in texture for forming soft peaks can also be accompanied by a softening in colour to the trained eye, that is to say the colour of the paste 32 becomes a little paler as the mousse-like texture is achieved, but not so far as to reduce the vibrancy of the colour retained by the cooking process described herein.

The chopping process in a bowl cutter can be extended in duration, until the physical appearance of the paste 32 starts to illustrate the desired mousse-like texture. Where a mill is used and the paste 32 has been milled and is not illustrating the mousse-like texture, the paste 32 can be re-passed through the mill to achieve the desired consistency.

The next stage of the process is to assess the consistency of the fruit or vegetable paste and for some fruits and vegetables, an additional step is required to adjust the mixture to increase its flow characteristics to comply with a predetermined standard. To adjust the flow characteristic fibre is added and then the paste consistency is re-assessed. This can be conducted by testing whether the paste 32 can hold soft peaks. If required, more fibre is added until the desired consistency of the paste 32 is achieved. Starch can then be added to assist in achieving the desired final mousse-like texture.

The International Dysphagia Diet Standardisation Initiative (IDDSI) Framework

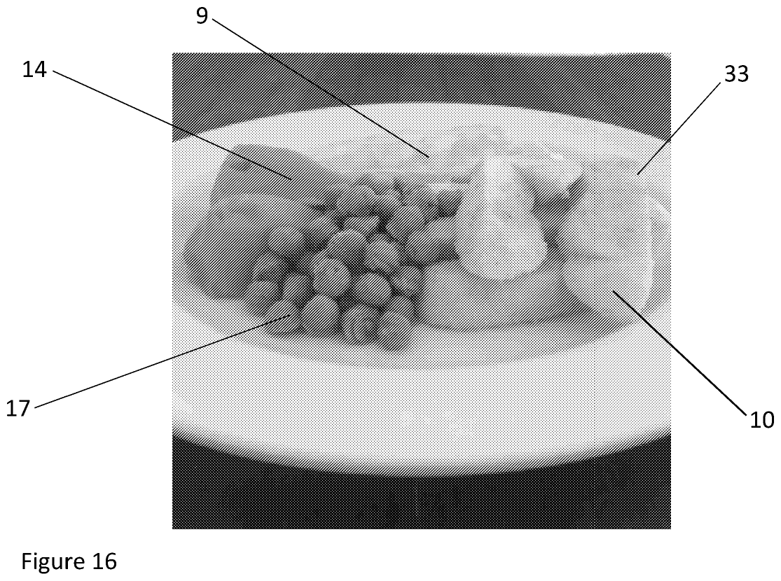

While an international standardised system has not yet been established, a framework has been put in place to assess the consistency of both food and drink for those affected by dysphagia. The IDDSI uses specific terminology and definitions to describe texture modified foods and thickened liquids comprising 8 defined and colour coded levels (0-7). The studies conducted in putting together this framework found many factors that influence the flow behaviour and thus the rating of a food or a drink. These factors include: viscosity, density, yield stress, temperature, propulsion pressure, fat content and shear rate. In taking each of the above factors into consideration, the food and drink rating of 0-7 is derived from a gravity flow test. The test measures a retained volume of food or drink from a 10 mL sample left in a syringe after 10 seconds of flow. The categories rated 0-7 are illustrated in FIG. 16.

The IDDSI framework equates pureed food with an “extremely thick” liquid, which is defined as a liquid that sits on a spoon and does not flow off it. This is contrasted to a “moderately thick” liquid which would drip in dollops off the end of the spoon. The difficulty with a product that is too solid must be carefully balanced against the product being too viscous and flowing into the airways of the consumer, leading to additional medical complications.

Once the fruit or vegetable paste 32 meets the required consistency, the paste 32 is introduced into the sterile lining material of the mould recess 22 of the die 20 to set the paste 32 into the finished fruit or vegetable shape. The introduction of the paste 32 into the recess 22 can be done when the paste is warm or cold, depending on the selected fruit or vegetable. A vegetable or fruit shaped recess 22 having a complex texture and/or fine detail can benefit from the paste being introduced into the die 20 while still warm, as this fills the recess 22 more completely.

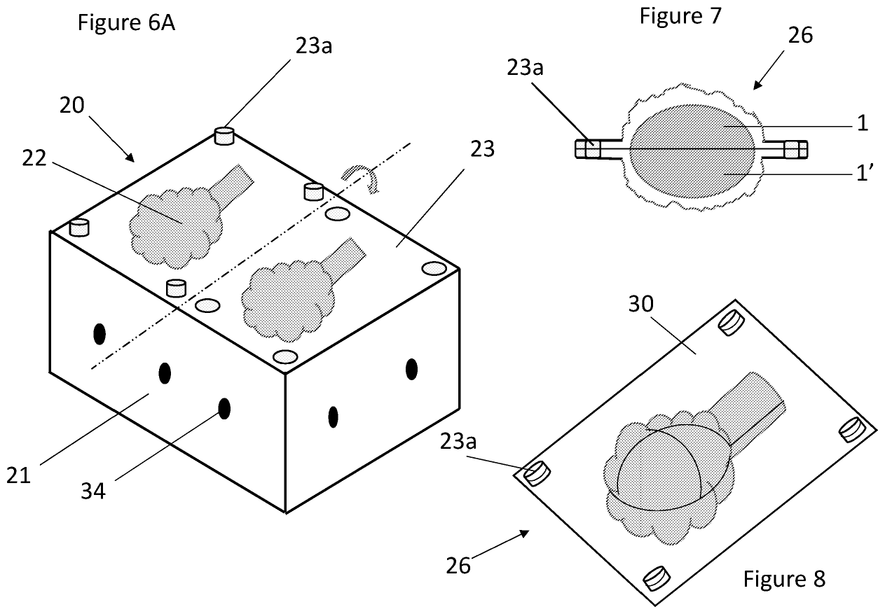

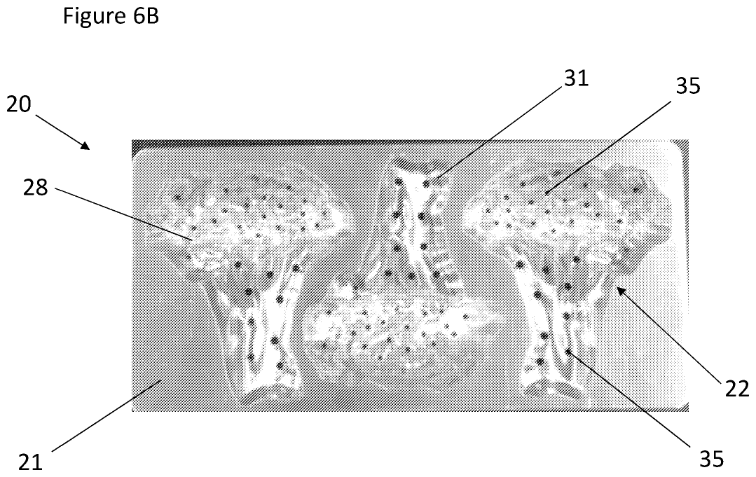

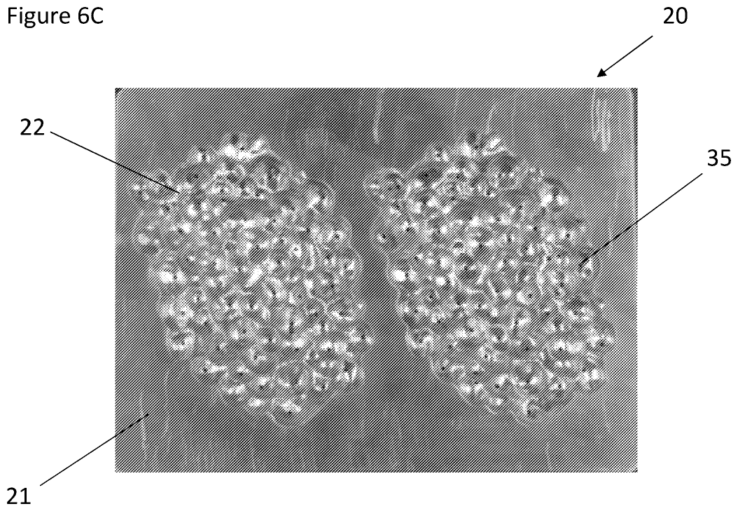

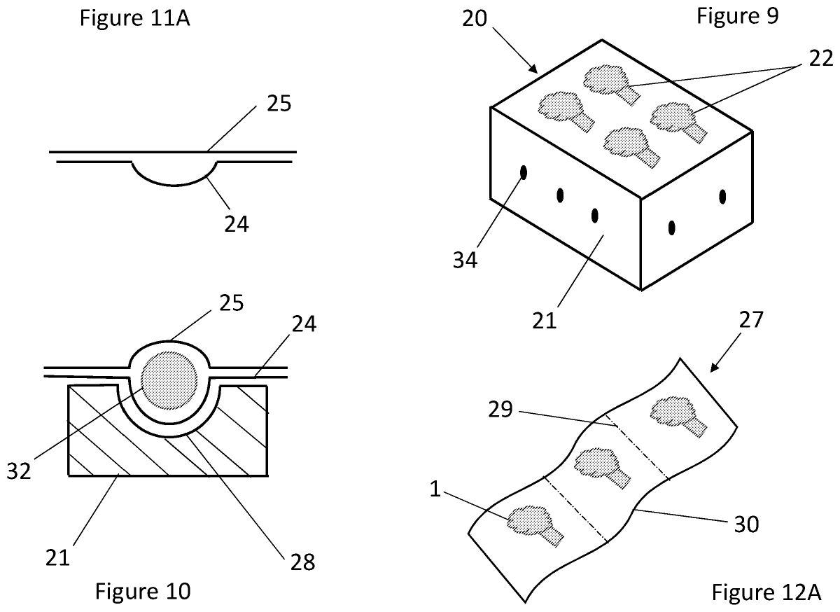

The die 20 is cut from an aluminium billet. The billet is machined to create a die base 21 and at least one moulding recess 22, illustrated in FIGS. 6A-6C. The moulding recess 22 can be CNC cut or laser cut and is shaped and textured to resemble a vegetable. Accordingly, the details and form of the recess 22 can be taken from a 3D scan of a real fruit or vegetable or portion as required. Alternative forms of moulding can be used to replicate more simplistic shapes. However, the 3D scanning techniques enable very complex mould forms to be created, increasing the illusion that the finished fruit or vegetable product 1 is a naturally prepared fruit or vegetable.

The recess 22 is formed into a top surface 23 of the die 20, and as such will produce a finished food product having a flat-base. Where a fully rounded food product 1 is desired, a pair of flat-based food products can be fused together, as illustrated with the vegetable product of FIG. 1.

The top surface 23 of the die 20 can also provide tabs 23a or alternative cooperating protrusions and recesses to assist in the sealing and packaging of a finished food product 1, illustrated in FIGS. 7 and 8 as a single serve of product 1.

Effectively, the broccoli floret 1 in FIG. 1 constitutes a double portion of the finished texture modified food product. However, each individual fruit or vegetable product constitutes a single-serve portion, typically between 30-40 g. When a consumer's needs have been assessed, a meal can be configured with the correct number of food products 1 to provide the required nutritional requirements. Furthermore, the portion size in any given meal can be easily increased or decreased to account for fluctuations in the consumer's appetite. Traditional puree moulds do not provide this level of flexibility with no variation for small, medium and large portions. This can lead to waste of uneaten food and deterioration of the consumer's appetite, where the volume of food presented is off putting. Additionally, the texture modified food product can be off putting when an unrealistic or unnatural portion size is placed on a standard dinner plate.

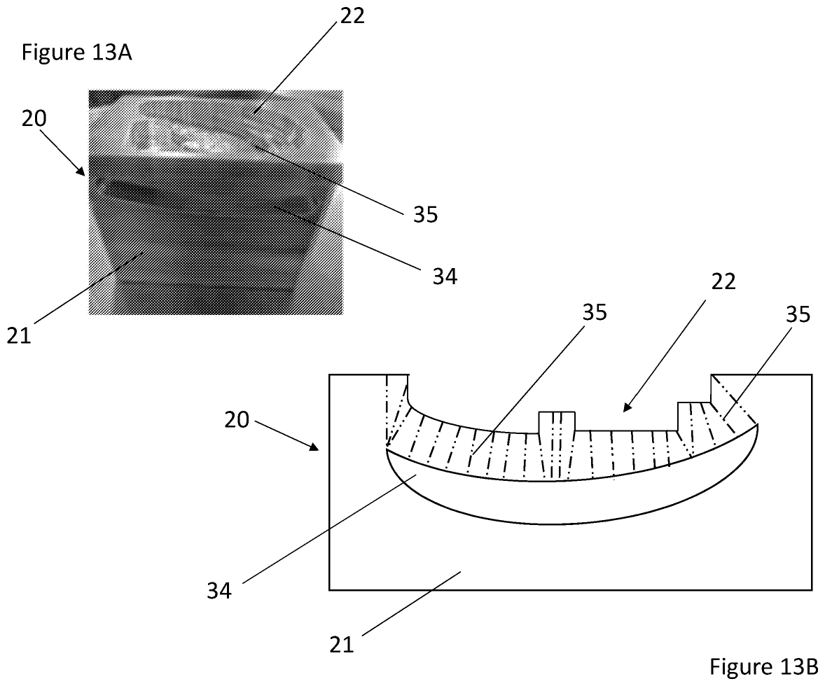

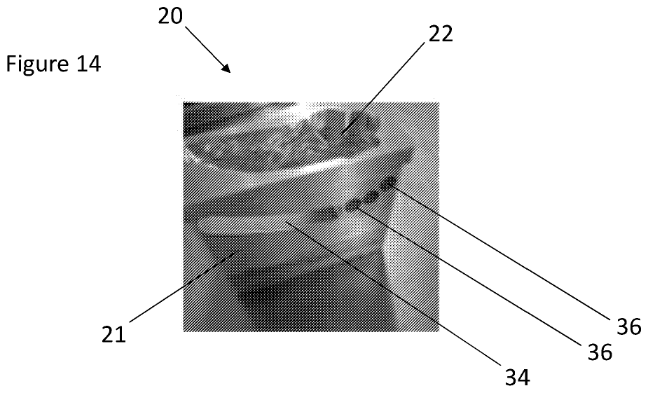

The base 21 of the die 20 comprises a primary air passage 34 to facilitate thermomoulding or thermo-forming of the food product 1 (see FIG. 13). In some embodiments at least one supplementary air passage 36 is provided to increase suction to targeted portions of the moulding recess 22 (see FIG. 14). The or these supplementary air passages 36 facilitate use of more complex moulding recesses 22 to provide more detailed and thus more realistic looking fruit and vegetable products. Some existing puree foods have been set into food moulds made from children's toys, such as those designed for plasticine or PlayDoh™; however, the end product is unrealistic and unappealing.

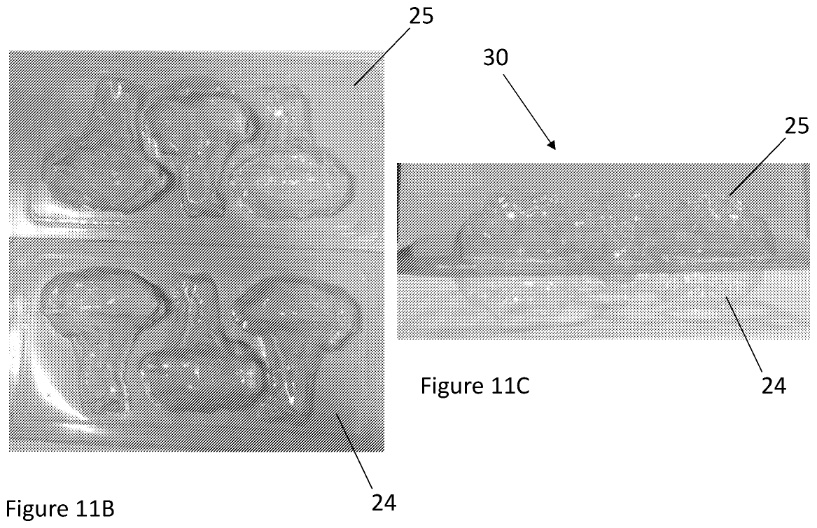

The die 20 is designed to be used with a lining material 24 laid out over the recess 22 of the die 20, illustrated in FIG. 10. The lining material 24 is flexible and pliable enough to take on a complex form of the recess 22. When the die 20 is inserted into a thermo-moulding machine, a vacuum is created that sucks air out of the recess 22 via the vacuum passages 35, to draw the lining material 24 tightly against a surface 28 of the moulding recess 22 in preparation for receiving the fruit or vegetable paste 32, illustrated in the cross-sectional view of FIG. 11A.

The lining material 24 can be made from a number of suitable sterile food grade films, including high barrier laminated films, made from Polyvinyl chloride (PVC), Nylon and Polyethylene terephthalate (PETE or PET).

A thermo-former (or vacuum forming machine) relies on extracting vented air out a single hole or a row of horizontal holes along the base 21 of the die 20. Due to the complexity of the desired die in this invention, evenly spaced holes along the base 21 were found to produce an uneven vacuum across the geometry of the recess 22 where the film or lining material 24 was not fully conforming to the shape and form of the moulding recess 22. The addition of supplementary air passages 36 through the die 20 and die base 21 allow the vacuum across the surface of the recess 22 to be tailored, resulting in the lining material 24 and subsequently the paste 32 conforming more closely to the shape of the moulding recess 22.

The vacuum passages 35 and supplementary air passages 36 are formed at various angles through the die base 21, to draw the lining material 24 against the moulding recess 22 at a 90-degree angle to the surface 28 (illustrated in FIG. 13A and FIG. 13B).

In some embodiments a second upper mould is also inserted into the thermo-moulding machine so that a two-sided moulded fruit or vegetable product can be created, illustrated in the cross-sectional view of FIGS. 11B-11C. The paste 32 is injected (not illustrated) into the recess formed between the two sides of the mould after the vacuum is applied to draw the upper 25 and lower 24 lining materials against the recess surfaces.

Additional air passages through the base 21 into the recess 22 will increase the vacuum and assist in pulling the lining 24, 25 into any tightly contoured forms of the recess 22. This is particularly useful where the recess 22 is deep or complex in form.

For ease of packaging, the lining material 24 can be selected to also be a packaging material for the finished texture modified food product 1. This has the added benefit of reducing head space (and trapped air) within the package product 26 thereby improving protection of the fruit or vegetable product from freezer burn. This is of importance as a texture modified fruit or vegetable product is more susceptible to freezer burn than a natural frozen product due to the chemical changes in the cellular structure of the fruit or vegetable product during processing. To this end, a second layer of lining material 25, of the same or a different material, can be placed over the recess 22 after the recess 22 has been filled. The upper lining material 25 and lower lining material 24 can then be sealed to one another to form a pouch or package 30 for the product 1, illustrated in FIGS. 7 and 8.

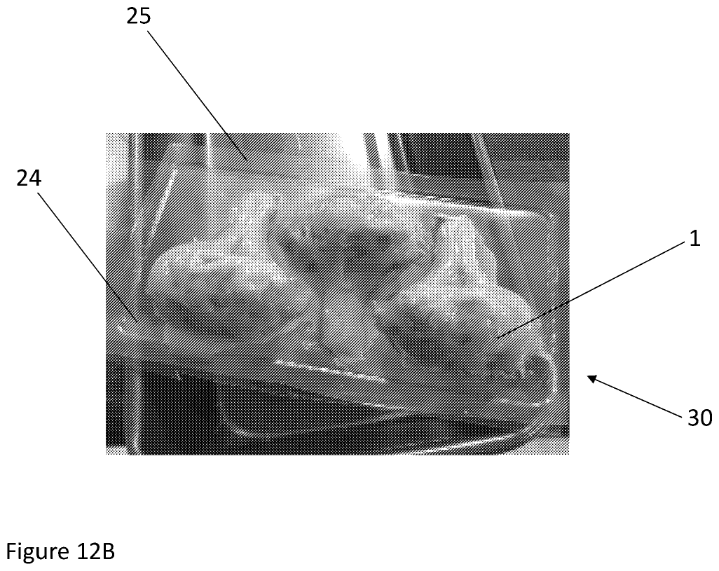

The texture modified food product 1 can also be formed and packaged in a multi-pack 27 as illustrated in FIGS. 12A and 12B. The multi-pack can have perforations 29 or be otherwise separable, to allow a single 26 or multi-serve 27 of the food product 1 to be selected and prepared for consumption. The remaining, unused serves of the multi-pack 27 can be returned to freezer storage or cold storage for use at a later time.

The finished packaged food product can be air evacuated prior to sealing the package 30. In some embodiments the package 30 is back flushed with carbon dioxide and nitrogen to remove suspended oxygen from the moulded fruit or vegetable product 1.

Additionally, the sealed evacuated package can be pasteurising to increase usable shelf life of the packaged product. Pasteurising the sealed product significantly reduces the microbial count of the texture modified food product 1. In many countries, nominated vulnerable groups e.g. hospital patients, aged care residents etc. will have standards for “read-to-eat” products, particularly proteins which are the highest risk products. Duration and temperature of the pasteurisation process can be tailored to meet the required national standards, as required.

In some embodiments, the sealed evacuated package 30 can be high pressure processed (HPP also referred to as Pascalisation). While effectively reducing the microbial count of the food and destroying pathogens, the HPP process has minimal effect on the colour, flavour or vitamin content in the vegetable based food product, unlike traditional pasteurisation techniques, where the heat from the pasteurisation process can discolour some foods and alter flavour and nutrients therein.

HPP is effectively a cold pasteurization technique, where the sealed evacuated package 30 is exposed to a high level of hydrostatic pressure, up to 600 MPa, for a few seconds to a few minutes. The high level of pressure exerted by the water surrounding the sealed package effectively inactivates certain microorganisms and enzymes in food, without the application of heat.

In some embodiments where a fruit or vegetable is to be processed to form a texture modified food product, the cooking process can be reduced and in some cases eliminated, where the cold pasteurisation process is a sufficient “kill step” to reduce the bacteria count on the selected fruit or vegetable. The standard for killing bacteria in high protein foods is very high and some form of cooking process will almost always be required for these high protein foods to achieve the required safety standards.

In Victoria, Australia, the government has a food business classification system, in which the class 1 service sector encompasses food businesses that provide meals to patients in: hospitals, hospices, child services, vulnerable persons, meal delivery organisations, nursing services, and aged persons. The vegetable products 1 described herein are manufactured to conform to these requirements under the Food Act 1984.

FANZA provides standards for ready to eat products in a class 1 (any nominated vulnerable group e.g. hospital patients, aged care residents). Pasteurisation will extend the product's shelf life under refrigeration.

The vegetable paste 32 can be deposited into the mould 20 in a chilled state. However, where the recess 22 is a complex form, warming the paste 32 prior to introducing the paste into the mould can assist in filling the mould recess and reducing voids and air bubbles in the finished vegetable product 1. To speed up the setting time of the paste 32 the mould 20 can be chilled such that contact with the mould starts the paste 32 setting on contact.

The mould can be manufactured to provide one or more than one recess, shaped to conform to a generic species of the raw vegetable selected to form the vegetable paste. The shape of the desired product and size of thermo-former used will limit the available options for design of the die or mould.

Where the mould provides a plurality of shaped recesses 22, each of the plurality of shaped recesses being configured to set the fruit or vegetable paste into a form of the generic species of raw fruit or vegetable selected to form the vegetable paste. Each of the plurality of shaped recesses has an equal volume. The shaped recesses are sized for small portions between 30-40 g as too much food can be off-putting or overwhelming to the consumer with dysphasia. With the texture modified food product 1 formed and set in 30 g portions, small or large meals can easily be configured to cater for changes in appetite of the consumer and makes for a more realistic appearance of the finished texture modified meal.

After the sealed pouch is pasteurised, it is rapidly chilled such as in a blast chiller and then frozen. The frozen product facilitates storage, handling and plating of the texture modified food 1, prior to heating and serving. While heating of the finished fruit or vegetable product is initially carried out immediately prior to serving and consumption of the product, as the fruit or vegetable product retains its shape through the heating process, the fruit or vegetable product can be reheated during a meal session as feeding times can be slow for these consumers and the product may cool faster that their rate of consumption. Not all texture modified food products will require heating and some fruits and vegetables, for example lettuce or tomato can be simply thawed and served, without heating.

The finished package 30, once frozen, reduces contamination from food handling as the product stays in the finished package, provides for an increased shelf-life and facilitates ease of transport and distribution.

For some fruit or vegetables, the paste 32 requires additives to help the paste retain or acquire the required consistency and flow characteristics. These additives may assist in the overall forming of the texture modified food product 1 and can also assist with product form retention during heating of the fruit or vegetable product 1.

Any required additives are introduced into the paste 32 prior to setting the paste in the die 20. As fruits and vegetables have different moisture levels, a small amount of vegetable fibre can assist with giving back structure to the paste 32 without changing the smoothness of the paste 32 required to meet the proposed international standard or changing the flavour profile of the paste 32.

For many fruits and vegetables, a fibre content in the paste of between 1-5% is sufficient to achieve the required structure. Preferably about 3% of vegetable fibre is added to the paste 32.

For some fruits and vegetables Xanthan gum can be added to the paste 32. The Xanthan gum can prevent some bleeding of liquid from the vegetable product 1 while defrosting. The Xanthan gum helps the paste 32 retain moisture and thereby prevent the fruit or vegetable product 1 from drying out. A Xanthan gum content of between 0.1-0.5% is sufficient to reduce bleeding of liquids. Preferably about 0.3% of Xanthan gum is added to the paste 32.

Agglomerated modified potato starch (AMPS) can also be added to the paste 32 to help assist the fruit or vegetable product in retaining its shape when being heated for service. Both AMPS and Xanthan gum give the paste 32 a mousse-like texture and inhibit the moulded fruit or vegetable product 1 structure from losing its form when heated. An AMPS content of between 1.0-3.0% is sufficient to retain the products shape through a heating process. Preferably about 2.5% of AMPS is added to the paste 32.

The AMPS can be directly added to the paste 32 and will evenly distribute therethrough. Additional AMPS will naturally thicken the paste 32 and does not require the addition of heat to do so. The addition of AMPS until now has been avoided as thickening of the paste 32 would appear contrary to the process of producing the puree. However, through trial and experimentation it was found that the relevant standards can be met, and the fruit or vegetable product can still retain sufficient structure to hold its shape and form through a heating process.

While alternative gels and starches can be added to the paste 32, such as tapioca starch, mashed potato and commercial gelling agents; during trials, these were found to change the flavour profile of the paste 32. The tapioca starch also changes the texture of some vegetables adversely. Additionally, some gelling agents contain pectin and agar, which require heating and thus affect the colour of the paste 32. They are also not particularly stable when microwaved, resulting in the loss of the shape and form of the fruit or vegetable product prior to consumption.

The additives are selected from at least one of: Xanthan gum; modified potato starch; agglomerated modified potato starch (AMPS); natural vegetable fibre; bamboo fibre; flavourless starch; salt and pepper. However, a combination of additives including a ratio percentage of Xanthan gum (XG), agglomerated modified potato starch (AMPS) and a natural vegetable fibre (bamboo fibre) was found to provide the required consistency in the paste 32.

The texture modified food product 1 provides a nutrient rich food that can be eaten and digested by people suffering from dysphagia. Aside from retaining minerals and vitamins present in the raw fruit or vegetable from which the paste is formed, the processing method described herein retains the natural colours and flavour profiles of the selected fruit or vegetable.

Unlike more traditional pureeing processes using a blender that would require a liquid component to puree the product, the paste 32 does not include a stock or additional cooking water, thus the nutrient levels are significantly higher than currently available puree products.

Minimal additives into the paste, prior to setting, allows the vegetable product to be frozen, transported and defrosted and heated, while retaining the desired shape of the selected vegetable.

The individual, microwavable, portions allow for balancing and monitoring meals simply and in a convenient manner while also facilitating easy variation for loss or increase in appetite. It is contemplated that a facility can maintain a supply of multiple fruits and vegetables, all in pre-portioned packs, such that a consumer can select any desired combination of fruit and vegetable to accompany a meal. It is further contemplated that pre-assembled complete meals can be assembled and packaged and sold as convenience meals. For hospitals, and aged care facilities, this can bring a much-needed flexibility to their catering operation. All vegetable products 1 are prepared to the predetermined standard, and can be delivered and stored in bulk. With minimal work, individual plates of food can be made up to an individual's preference from the frozen/chilled vegetable products, providing nutritious and varied modified textured meals.

The fruit or vegetable product 1 is selectively heated prior to consumption, unless it is a salad or fruit product that merely requires thawing before consumption.

As the fruit or vegetable product 1 can be sensitive to moisture loss when heated, the fruit or vegetable product 1 should be covered when heated.

While the fruit or vegetable product 1 can be steamed or microwaved, it is also configured to be passed through a banqueting system, or other heated trolley systems such as Berlodge™, Regethermic™ or Rational™ carts. These methods are suitable for high volume catering and as used in some hospitals and aged care facilities.

A typical banqueting system has a heating cycle of about 9-12 minutes at temperatures of about 120° Celcius. Banqueting systems are used to heat the fruit or vegetable product 1 once arranged on a plate. The Banqueting system heats the plate and the texture modified food product together, and the hot plate continues to heat the tmf product after the plate is removed from the system. Due to the timing and temperatures used in a banqueting system the fruit or vegetable product 1 will not change colour, flavour or form because of this process, thereby preserving the visually appealing colour, taste, shape and nutritional value of the packed tmf product 1 as supplied.

Dressing a Texture Modified Food Product

To further create a visually appealing modified texture food product and better resemble the look and flavour of a non-tmf fruit or vegetable a dressing or coating 33 can be added to the tmf product. For example, a potato product can be coated to resemble a roast potato 10 (illustrated in FIG. 5) or a French fry, wedge or chip (illustrated in FIG. 16).

The coating 33 is made from potatoes. A raw potato is thinly sliced or shredded or grated. The comminuted potato pieces are then fried until crisp and left to cool. During the cooing period, excess oil is drained from the fried potato pieces.

As an alternative, commercially available potato chips (crisps) can be used to speed up the preparation time. The fried potato pieces can be salted to enhance natural flavour.

The salted or unsalted fired potato pieces are then broken down into a fine powder. This can be achieved using a bowl cutter, a food processor, a shearing mill or a mill stone. The resulting fine powder has a sheen, making it appear damp, from the oil content therein.

The potato powder can be additionally flavoured, for example, by adding dry turmeric powder and dried sweet paprika powder, to about 0.5% weight. These spices are merely exemplary and any number of spices and herbs can be added to the potato powder to achieve a range of coatings 33 providing different flavour profiles. An acid can also be introduced into the coating to produce a salt and vinegar flavour profile.

The finished coating 33 can be stored in an air-tight container.

To apply the coating 33, the vegetable product is cut or formed into a desired end shape. For example, a potato shaped vegetable product may be cut into “chips” or half or quarter potato shapes akin to roast potato pieces. These modified potato products can then be allowed to thaw before coating, or being covered with butter to serve as a buttered/steamed potato product.

A fine spray or mist of water or salt water can be applied to the surface of the texture modified food product to soften the surface and facilitate better adhesion of the coating 33. The tmf product can be dusted, or rolled in the coating 33, as desired.

The coated tmf product is left for about an hour, to allow the water mist and exterior surface water on the tmf product to be absorbed into the coating, softening it, and ensuring that the required tmf standards are met by the coated tmf product 1.

The coated tmf product is then heated ready for service. At which time the heating of the product adheres the coating 33 to the vegetable product and provide additional colour, flavour and texture to the vegetable product when served.

It will be appreciated by persons skilled in the art that numerous variations and modifications may be made to the above-described embodiments, without departing from the scope of the following claims. The present embodiments are, therefore, to be considered in all respects as illustrative of the scope of protection, and not restrictively.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

LEGEND

| No. | |
|---|---|
| 1 | Texture modified food product |
| 2 | Head |
| 3 | Stalk |
| 4 | Bud texture |
| 5 | Part line |
| 6 | Carrot |
| 7 | Casserole meal |
| 8 | Texture modified carrot product |
| 9 | Texture modified meat product |
| 10 | Texture modified potato product |
| 11 | |
| 12 | Stir-fry meal |
| 13 | |
| 14 | Texture modified pumpkin product |
| 15 | Texture modified rice product |
| 16 | Roast meal |
| 17 | Texture modified pea product |
| 18 | |
| 19 | Gravy (viscosity modifier) |
| 20 | Die |
| 21 | Base |
| 22 | Moulding recess |
| 23 | Closing tab |
| 24 | Upper layer |
| 25 | Lower layer |
| 26 | Individually packaged product |
| 27 | Multi-pack product |
| 28 | Surface of recess |
| 29 | Perforation lines |
| 30 | Packaging |
| 31 | Second surface of recess |
| 32 | Texture modified food paste |
| 33 | Coating |
| 34 | Primary air passage |
| 35 | Vacuum passages |
| 36 | Supplementary air passage |

1. A method of preparing a texture modified food product for consumption by a dysphagic consumer, comprising the steps:
a) commencing cooking of a raw fruit or vegetable;
b) arresting the cooking of the fruit or vegetable to provide a partially cooked fruit or vegetable;
c) chopping the partially cooked fruit or vegetable finely to form a paste; and
d) setting the paste in a mould to form the texture modified food product shaped and textured to a generic shape of the fruit or vegetable selected to form the paste.

2. The method of claim 1, wherein the step of cooking the raw fruit or vegetable involves plunging the fruit or vegetable into boiling water for a predetermined time period.

3. The method of claim 1, wherein the step of arresting the cooking of the fruit or vegetable involves plunging the fruit or vegetable into cold water and/or iced water.

4. (canceled)

5. The method of claim 1, wherein the step of chopping the partially cooked fruit or vegetable is performed with a shear-blade cutter or a bowl cutter.

6. The method of claim 1, additionally continuing the step of chopping the partially cooked fruit or vegetable until the paste takes on a mousse-like consistency.

7. (canceled)

8. (canceled)

9. (canceled)

10. The method of claim 1, further comprising the step of introducing an additive into the mixture prior to setting the paste in the mould.

11. The method of claim 10, wherein the additive is selected from at least one of: Xanthan gum; modified potato starch; agglomerated modified potato starch (AMPS); natural vegetable fibre; bamboo fibre; flavourless starch; salt and pepper.

12. (canceled)

13. (canceled)

14. The method of claim 1, further comprising the step of integrating the mould with a thermoforming machine.

15. (canceled)

16. The method of claim 1, setting the paste in the mould, wherein the mould provides a recess shaped and/or textured to the generic species of the raw fruit or vegetable selected to form the paste.

17. The method of claim 1, wherein the mould provides a plurality of recesses shaped and/or textured to the generic species of the raw fruit or vegetable selected to form the paste.

18. (canceled)

19. The method of claim 1, further comprising the step of lining the mould with a first layer of packaging material prior to introducing the paste therein.

20. The method of claim 19, vacuum assisting the drawing of the first layer of packaging material into the mould prior to receiving the paste.

21. (canceled)

22. The method of claim 19, further comprising the step of disposing a second layer of packaging material over the mould after the paste has been received therein and fusing the second layer with the first layer of packaging material thereby forming a sealed pouch around the moulded texture modified food product.

23. The method of claim 22, further comprising the step of air evacuating the sealed pouch prior to sealing.

24. The method of claim 22, further comprising the step of back-flushing the pouch with carbon dioxide and nitrogen to remove suspended oxygen from the moulded texture modified food product prior to sealing the pouch.

25. The method of claim 22, further comprising the step of hot pasteurising the sealed pouch to increase usable shelf life of the packaged product.

26. The method of claim 22, further comprising the step of cold pasteurising the sealed pouch to increase usable shelf life of the packaged product.

27. The method of claim 22, further comprising the step of freezing the sealed pouch for distribution.

28. A texture modified food product made by the method of claim 1.

29. A texture modified food product for consumption by a dysphagic consumer, comprising;
a paste formed from a single fruit or vegetable species, the paste retaining the colour and the taste or the single fruit or vegetable species; and
an additive selected from a group comprising: Xanthan gum; Guar gum; modified potato starch; agglomerated modified potato starch (AMPS); natural vegetable fibre; bamboo fibre; flavourless starch; salt and pepper,
wherein the texture modified food product is shaped and textured to a generic shape of the single fruit or vegetable species selected to form the paste.

30. (canceled)

31. (canceled)

32. (canceled)

33. (canceled)
